(19) United States
(12) Patent Application Publication
(10) Pub. No.: US 2021/0333916 A1
(43) Pub. Date: Oct. 28, 2021

(54) TOUCH DISPLAY DEVICE

(71) Applicants: Inventec (Pudong) Technology Corporation, Shanghai (CN); INVENTEC CORPORATION, Taipei (TW)

(72) Inventors: Po-Hsiang Wu, Taipei (TW); Yi-Wei Chang, Taipei (TW); Sheng-Hao Huang, Taipei (TW)

(21) Appl. No.: 16/899,725

(22) Filed: Jun. 12, 2020

(30) Foreign Application Priority Data
Apr. 23, 2020 (CN) 202010326399.8

(51) Int. Cl. G06F 3/041

(52) U.S. Cl. CPC G06F 3/0412

(57) ABSTRACT

A touch display device including a display assembly, a touch panel, a first seal adhesive, an adhesive layer and a second seal adhesive. The touch panel is stacked on a side of the display assembly. The first seal adhesive is clamped by the display assembly and the touch panel and includes a sealing portion and two protruding portions. The display assembly, the touch panel, and the sealing portion together form an accommodation space. The two protruding portions protrude from the sealing portion and extend away from the accommodation space so as to together from an opening connected to the accommodation space. The adhesive layer is accommodated in the accommodation space to adhere the display assembly and the touch panel. The second seal adhesive is attached to the two protruding portions to seal the opening and the accommodation space.

### CROSS-REFERENCE TO RELATED APPLICATIONS

This non-provisional application claims priority under 35 U.S.C. § 119(a) on Patent Application No(s). 202010326399.8 filed in China, on Apr. 23, 2020, the entire contents of which are hereby incorporated by reference.

### BACKGROUND OF THE INVENTION

### Technical Field of the Invention

The invention relates to a touch display device, more particularly to a touch display device including an adhesive layer.

### Description of the Related Art

In general, a touch display device includes a touch panel and a display assembly. In order to lower the manufacturing cost, the touch panel and the display assembly are commonly adhered to each other by curing a layer of liquid optically clear adhesive (LOCA) therebetween. In more detail, a seal adhesive will firstly be provided between the touch panel and the display assembly to surround and form an internal space with the touch panel and the display assembly while leaving an opening for the LOCA to be injected into the space, and then the LOCA will cure in the space to form an adhesive layer for adhering the touch panel and the display assembly. Moreover, to ensure the reliability of the adhesive layer adhering the touch panel and the display assembly, redundant air in the space surrounded by the seal adhesive will be removed via the opening of the seal adhesive while or before the LOCA is curing.

It is found that as the touch display device stays at high temperature for a long time, such as at a temperature of Celsius 80 to 85 degrees for 1000 hours, the adhesive layer made from LOCA may melt back into liquid form and flow into the display panel of the display assembly via the opening of the seal adhesive and thus damaging the display panel. Meanwhile, the escaping of the LOCA may introduce ambient air into the space via the opening to fill the part occupied by the adhesive layer, thus forming air bubbles on the display panel and affecting the appearance of the touch display device.

### SUMMARY OF THE INVENTION

The invention is to provide a touch display device allowing the opening of the seal adhesive that is connected to the accommodation space for accommodating adhesive layer to be sealed.

One embodiment of this invention provides a touch display device including a display assembly, a touch panel, a first seal adhesive, an adhesive layer and a second seal adhesive. The touch panel is stacked on a side of the display assembly. The first seal adhesive is clamped by the display assembly and the touch panel and includes a sealing portion and two protruding portions. The display assembly, the touch panel, and the sealing portion together form an accommodation space. The two protruding portions protrude from the sealing portion and extend away from the accommodation space so as to together from an opening connected to the accommodation space. The adhesive layer is accommodated in the accommodation space to adhere the display assembly and the touch panel. The second seal adhesive is attached to the two protruding portions to seal the opening and the accommodation space.

Another embodiment of this invention provides a touch display device including a display assembly, a touch panel, a first seal adhesive, an adhesive layer and a second seal adhesive. The touch panel is stacked on a side of the display assembly. The first seal adhesive is clamped by the display assembly and the touch panel and has an opening. The display assembly, the touch panel and the first seal adhesive together form an accommodation space connected to the opening. The adhesive layer is accommodated in the accommodation space to adhere the display assembly and the touch panel. The second seal adhesive surrounds the first seal adhesive to seal the opening and the accommodation space.

According to the touch display device as discussed in the above embodiments of the invention, the second seal adhesive is able to seal the openings of the first seal adhesive by surrounding the first seal adhesive or being adhered to the protruding portion of the first seal adhesive, thereby sealing the accommodation space for accommodating the adhesive layer. By this way, even if the touch display device is at a temperature of about Celsius 80 to 85 degrees for 2000 hours, the melted adhesive layer will be prevented from flowing out of the accommodation space and therefore prevents air from being introduced into the adhesive layer, such that the display panel is prevented from being damaged and the air bubble is prevented from appearing on the display panel.

In addition, the protruding portion protrudes from the sealing portion and extends away from the accommodation space; that is, the protruding portion is located further away from the center of the touch display device than the sealing portion. This arrangement makes it easier and convenient to provide the second seal adhesive to the protruding portions without having interference with the components near the opening, such as touch panel.

### BRIEF DESCRIPTION OF THE DRAWINGS

The present invention will become more fully understood from the detailed description given hereinbelow and the accompanying drawings which are given by way of illustration only and thus are not limitative of the present invention and wherein:

FIG. 1 is a top view of a touch display device according to a first embodiment of the invention;

FIG. 2 is a top cross-sectional view of the touch display device in FIG. 1;

FIG. 3 is a partially enlarged side cross-sectional view of the touch display device in FIG. 1 taken along line 3-3;

FIG. 4 is another partially enlarged side cross-sectional view of the touch display device in FIG. 1 taken along line 4-4;

FIG. 5 is a top view of a touch display device according to a second embodiment of the invention;

FIG. 6 is a top cross-sectional view of the touch display device in FIG. 5; and

FIG. 7 is a partially enlarged side cross-sectional view of the touch display device in FIG. 5 taken along line 7-7.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

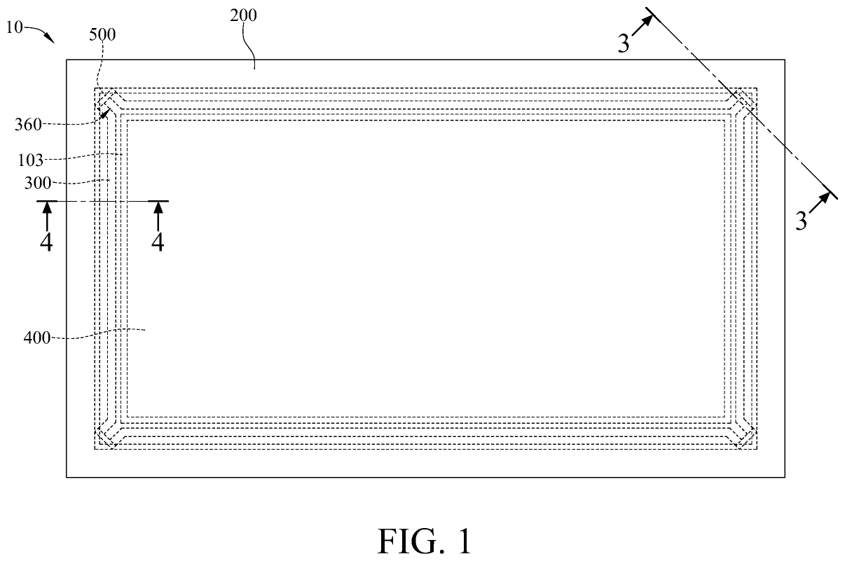

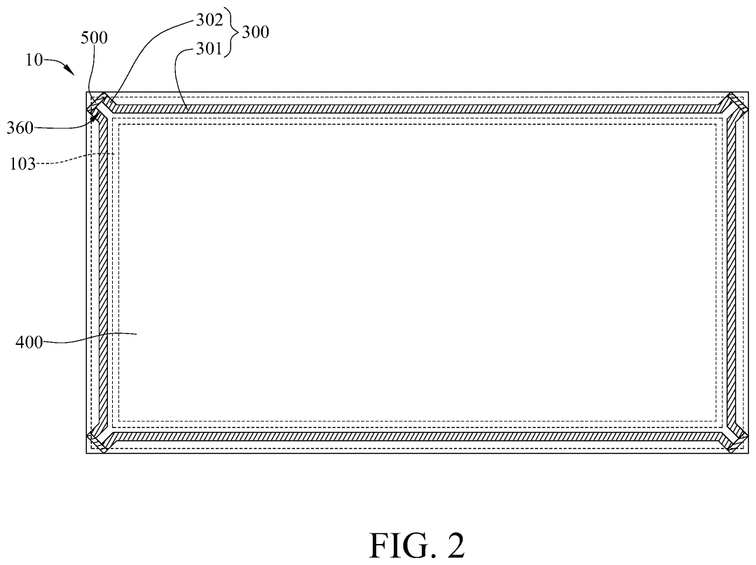

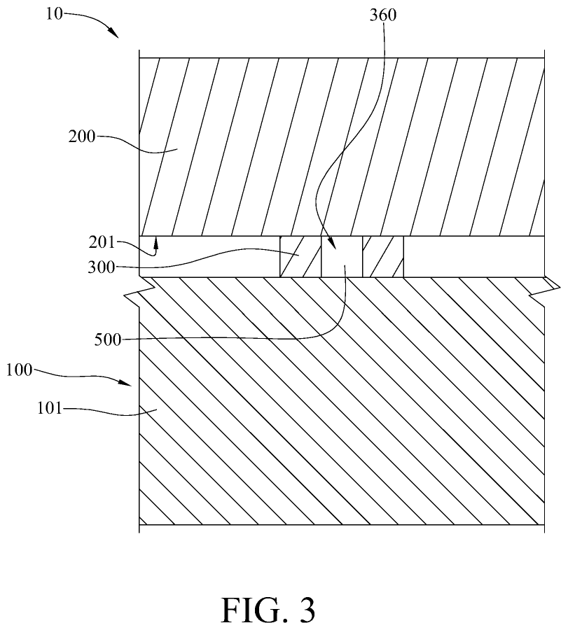

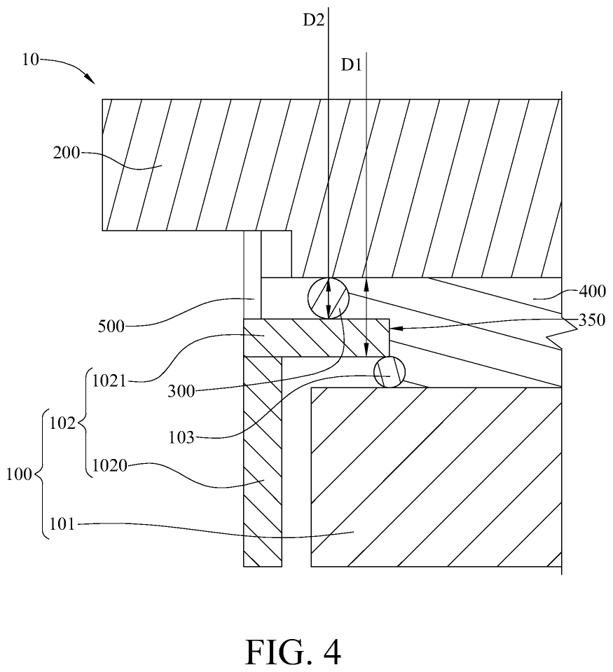

Please refer to FIG. 1 to FIG. 4, where FIG. 1 is a top view of a touch display device according to a first embodiment of the invention, FIG. 2 is a top cross-sectional view of the touch display device in FIG. 1, FIG. 3 is a partially enlarged side cross-sectional view of the touch display device in FIG. 1 taken along line 3-3, and FIG. 4 is another partially enlarged side cross-sectional view of the touch display device in FIG. 1 taken along line 4-4.

In this embodiment, the touch display device 10 includes a display assembly 100, a touch panel 200, a first seal adhesive 300, an adhesive layer 400, and a plurality of second seal adhesives 500.

In this embodiment, the display assembly 100 includes a display panel 101, a bezel 102, and a third seal adhesive 103. The display panel 101 is configured for displaying images. In this embodiment, as shown in FIG. 4, the bezel 102 includes a first covering portion 1020 and a second covering portion 1021 that are connected to each other to cover the display panel 101, where the first covering portion 1020 and the second covering portion 1021 respectively cover different sides of the display panel 101. The third seal adhesive 103 is clamped by the second covering portion 1021 of the bezel 102 and the display panel 101 and is configured to seal the space between the bezel 102 and the display panel 101.

The touch panel 200 is stacked on a side of the display assembly 100 and has a bottom surface 201. Specifically, the second covering portion 1021 is located between the touch panel 200 and the display panel 101, and the bottom surface 201 is located on a side of the touch panel 200 that is located close to the second covering portion 1021.

The first seal adhesive 300 is clamped by the second covering portion 1021 of the bezel 102 of the display assembly 100 and the touch panel 200 and includes a plurality of sealing portions 301 and a plurality of protruding portions 302. The display assembly 100, the touch panel 200, and the sealing portions 301 together form an accommodation space 350. Two adjacent protruding portions 302 respectively protrude from two adjacent sealing portions 301 and extend away from the accommodation space 350 so as to together from an opening 360 connected to the accommodation space 350. In other words, the protruding portions 302 are located further away from the center of the touch display device 10 than the sealing portions 301. In addition, in this embodiment, the protruding portions 302 are respectively located on four corners of the bottom surface 201 of the touch panel 200, but the invention is not limited thereto. In other embodiments, the protruding portions may not be located on the corners of the bottom surface of the touch panel.

In addition, in this embodiment, as shown in FIG. 4, a maximum distance D1 between the touch panel 200 and a surface of the second covering portion 1021 of the bezel 102 that is located away from the touch panel 200 is larger than a maximum distance D2 between the touch panel 200 and the first seal adhesive 300. Also, the third seal adhesive 103 is located on a side of the second covering portion 1021 of the bezel 102 that is located away from the first seal adhesive 300.

The adhesive layer 400 is accommodated in the accommodation space 350 so as to adhere the display assembly 100 and the touch panel 200, and the adhesive layer 400 is formed by, for example, curing a layer of liquid optically clear adhesive (LOCA). Moreover, the third seal adhesive 103 of the display assembly 100 is adhered to the adhesive layer 400. That is to say, the third seal adhesive 103 is able to seal the space formed by the bezel 102, the display panel 101, and the adhesive layer 400. Furthermore, the second covering portion 1021 of the bezel 102 extends from the first covering portion 1020 towards the accommodation space 350 and thus is adhered to the adhesive layer 400.

Note that the third seal adhesive 103 is optional; in other embodiments, the display assembly may not include the third seal adhesive 103.

Also, the invention is not limited by how the second covering portion 1021 of the bezel 102 extends. In other embodiments, the second covering portion of the bezel may extend from the first covering portion and extend away from the display panel.

The second seal adhesives 500 are respectively attached to the protruding portions 302 so as to respectively seal the openings 360 and thus together sealing the accommodation spaces 350 with the first seal adhesive 300.

Note that the invention is not limited by the quantities of the sealing portions 301, the protruding portions 302, and the second seal adhesives 500; in other embodiments, the first seal adhesive may include one sealing portion and two protruding portions, and the touch display device may include one second seal adhesive.

In this embodiment, the openings 360 are configured for the removal of redundant air existing in the accommodation space 350 while or before forming the adhesive layer 400, and the protruding portions 302 are configured to facilitate the sealing of the openings 360 by the second seal adhesives 500 after forming the adhesive layer 400. In detail, the protruding portions 302 protrude from the sealing portion 301 and extends away from the accommodation space 350 (i.e. the protruding portions 302 is located further away from the center of the touch display device 10 than the sealing portions 301), and each opening 360 is formed by adjacent two protruding portions 302. Therefore, comparing to other embodiments where the openings are formed by the sealing portions (i.e., the opening is located close to the center of the touch display device), forming the openings 360 by the protruding portions 302 located further away from the center of the touch display device 10 allows the operation of adhering the second seal adhesives 500 to the protruding portions 302 to be prevented from be interfered by the components around the openings 360, such as the touch panel 200.

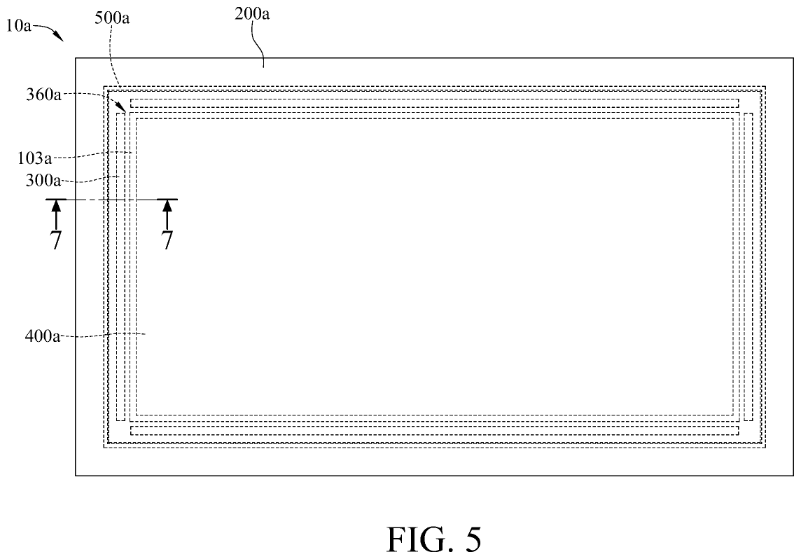

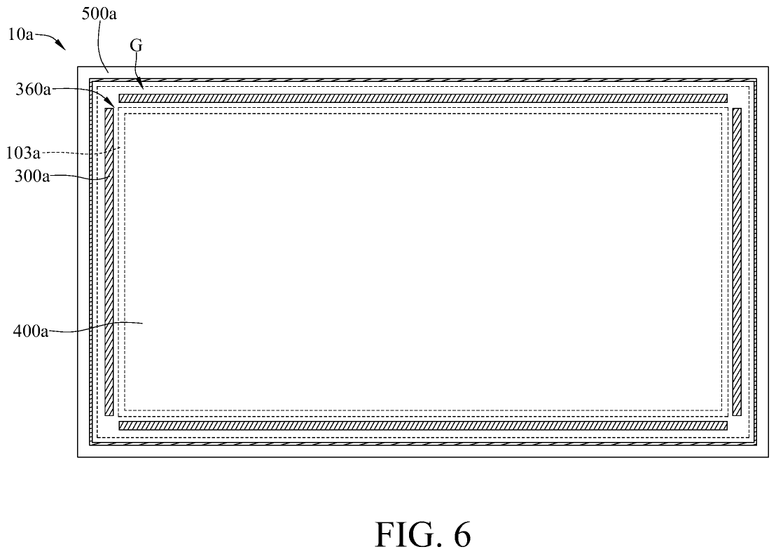

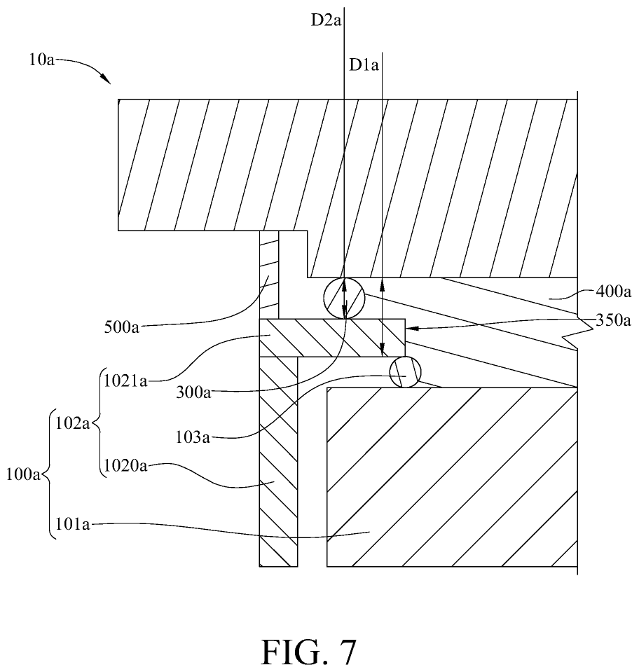

The invention is not limited by the way of sealing the openings 360 and the accommodation space 350. Please refer to FIG. 5 to FIG. 7, where FIG. 5 is a top view of a touch display device according to a second embodiment of the invention, FIG. 6 is a top cross-sectional view of the touch display device in FIG. 5, and FIG. 7 is a partially enlarged side cross-sectional view of the touch display device in FIG. 5 taken along line 7-7.

In this embodiment, the touch display device 10a includes a display assembly 100a, a touch panel 200a, a first seal adhesive 300a, an adhesive layer 400a and a second seal adhesive 500a.

In this embodiment, the display assembly 100a includes a display panel 101a, a bezel 102a and a third seal adhesive 103a. The display panel 101a is configured for displaying images. In this embodiment, as shown in FIG. 7, the bezel 102a includes a first covering portion 1020a and a second covering portion 1021a that are connected to each other to cover the display panel 101a, where the first covering portion 1020a and the second covering portion 1021a respectively cover different sides of the display panel 101a. The third seal adhesive 103a is clamped by the second covering portion 1021a of the bezel 102a and the display panel 101a.

The touch panel 200a is stacked on a side of the display assembly 100a and has a bottom surface 201a. Specifically, the second covering portion 1021a is located between the touch panel 200a and the display panel 101a, and the bottom surface 201a is located on a side of the touch panel 200a that is located close to the second covering portion 1021a.

The first seal adhesive 300a is clamped by the second covering portion 1021a of the bezel 102a of the display assembly 100a and the touch panel 200a and has a plurality of openings 360a. The display assembly 100a, the touch panel 200a and the first seal adhesive 300a together form an accommodation space 350a connected to the openings 360a. In addition, in this embodiment, the openings 360a are respectively located on four corners of the bottom surface 201a of the touch panel 200a.

In addition, in this embodiment, as shown in FIG. 7, a maximum distance D1a between the touch panel 200a and a surface of the second covering portion 1021a of the bezel 102a that is located away from the touch panel 200a is larger than a maximum distance D2a between the touch panel 200a and the first seal adhesive 300a. Also, the third seal adhesive 103a is located on a side of the second covering portion 1021a of the bezel 102a located away from the first seal adhesive 300a.

The adhesive layer 400a is accommodated in the accommodation space 350a so as to adhere the display assembly 100a and the touch panel 200a and the adhesive layer 400a is formed by, for example, curing a layer of LOCA. In addition, the third seal adhesive 103a of the display assembly 100a is adhered to the adhesive layer 400a. That is, the third seal adhesive 103a is able to seal the space formed by the bezel 102a, the display panel 101a and the adhesive layer 400a. Further, the second covering portion 1021a of the bezel 102a extends from the first covering portion 1020a towards the accommodation space 350a to be adhered to the adhesive layer 400a.

The second seal adhesive 500a surrounds the first seal adhesive 300a to seal the openings 360a and thus seal the accommodation space 350a. In addition, in this embodiment, there is a gap G between the second seal adhesive 500a and the first seal adhesive 300a. For example, a vacuum is created in the gap G so that the second seal adhesive 500a can create better seal for the openings 360a and the accommodation space 350a.

The invention is not limited by the quantity of the openings 360a. In other embodiments, the first seal adhesive may have one opening.

According to the touch display device as discussed in the above embodiments of the invention, the second seal adhesive is able to seal the openings of the first seal adhesive by surrounding the first seal adhesive or being adhered to the protruding portion of the first seal adhesive, thereby sealing the accommodation space for accommodating the adhesive layer. By this way, even if the touch display device is at a temperature of about Celsius 80 to 85 degrees for 2000 hours, the melted adhesive layer will be prevented from flowing out of the accommodation space and therefore prevents air from being introduced into the adhesive layer, such that the display panel is prevented from being damaged and the air bubble is prevented from appearing on the display panel.

In addition, the protruding portion protrudes from the sealing portion and extends away from the accommodation space; that is, the protruding portion is located further away from the center of the touch display device than the sealing portion. This arrangement makes it easier and convenient to provide the second seal adhesive to the protruding portions without having interference with the components near the opening, such as touch panel.

It will be apparent to those skilled in the art that various modifications and variations can be made to the present invention. It is intended that the specification and examples be considered as exemplary embodiments only, with a scope of the invention being indicated by the following claims and their equivalents.

1. A touch display device, comprising:
a display assembly;
a touch panel, stacked on a side of the display assembly;
a first seal adhesive, clamped by the display assembly and the touch panel and comprising a sealing portion and two protruding portions, wherein the display assembly, the touch panel, and the sealing portion together form an accommodation space, the two protruding portions protrude from the sealing portion and extend away from the accommodation space so as to together from an opening connected to the accommodation space;
an adhesive layer, accommodated in the accommodation space to adhere the display assembly and the touch panel; and
a second seal adhesive, attached to the two protruding portions to seal the opening and the accommodation space.

2. The touch display device according to claim 1, wherein the touch panel has a bottom surface facing toward the display assembly, and the two protruding portions are located on a corner of the bottom surface of the touch panel.

3. The touch display device according to claim 1, wherein the display assembly comprises a display panel and a bezel, the bezel covers the display panel, and the first seal adhesive is clamped by the bezel and the touch panel.

4. The touch display device according to claim 3, wherein the display assembly further comprises a third seal adhesive, the third seal adhesive is clamped by the bezel and the display panel and is adhered to the adhesive layer, and the third seal adhesive is located on a side of the bezel that is located away from the first seal adhesive.

5. The touch display device according to claim 4, wherein the bezel comprises a first covering portion and a second covering portion that are connected to each other, the first covering portion and the second covering portion together cover the display panel, the second covering portion extends from the first covering portion towards the accommodation space to be adhered to the adhesive layer.

6. A touch display device, comprising:
a display assembly;
a touch panel, stacked on a side of the display assembly;
a first seal adhesive, clamped by the display assembly and the touch panel and having an opening, the display assembly, the touch panel and the first seal adhesive together forming an accommodation space connected to the opening;
an adhesive layer, accommodated in the accommodation space to adhere the display assembly and the touch panel; and
a second seal adhesive, surrounding the first seal adhesive to seal the opening and the accommodation space.

7. The touch display device according to claim 6, wherein the touch panel has a bottom surface facing toward the display assembly, and the opening is located on a corner of the bottom surface of the touch panel.

8. The touch display device according to claim 6, wherein the display assembly comprises a display panel and a bezel, the bezel covers the display panel, and the first seal adhesive is clamped by the bezel and the touch panel.

9. The touch display device according to claim 8, wherein the display assembly further comprises a third seal adhesive, the third seal adhesive is clamped by the bezel and the display panel and is adhered to the adhesive layer, and the third seal adhesive is located on a side of the bezel that is located away from the first seal adhesive.

10. The touch display device according to claim 9, wherein the bezel comprises a first covering portion and a second covering portion that are connected to each other, and the second covering portion extends from the first covering portion toward the accommodation space to be adhered to the adhesive layer.
